(19) United States
(12) Patent Application Publication
(10) Pub. No.: US 2024/0326153 A1
(43) Pub. Date: Oct. 3, 2024

(54) METHOD FOR MANUFACTURING A STRUCTURE COMPRISING CAVITIES

(71) Applicant: COMMISSARIAT À L'ÉNERGIE ATOMIQUE ET AUX ÉNERGIES ALTERNATIVES, Paris (FR)

(72) Inventors: Mathieu MONTEREMAND, GRENOBLE CEDEX 09 (FR); Julien CIGNA, GRENOBLE CEDEX 09 (FR)

(21) Appl. No.: 18/616,783

(22) Filed: Mar. 26, 2024

(30) Foreign Application Priority Data
Mar. 27, 2023 (FR) 2302883

(51) Int. Cl. B23K 20/02; B23K 26/12; B23K 26/142; B23K 26/70; B23K 101/14; B23K 103/18

(52) U.S. Cl. CPC B23K 20/021; B23K 26/1224; B23K 26/142; B23K 26/70; B23K 2101/14; B23K 2103/18

(57) ABSTRACT

A method for manufacturing a structure comprising cavities, the method comprising the following steps: a) forming recessed areas in a first face of a substrate made of a first material, b) depositing a plate made of a second material over the first face of the substrate, so as to cover the recessed areas of the substrate, c) carrying out a resistance welding, an electron-beam welding or a transparent laser welding, preferably under vacuum, around the recessed areas, whereby the plate is welded onto the substrate and cavities are formed, and d) carrying out a step of hot isostatic pressing diffusion welding on the obtained assembly.

### TECHNICAL FIELD

The present invention relates to the field of heat exchanges and, more generally, to the structures comprising cavities, for example fluid circulation channels.

The invention relates to a method for manufacturing a structure including cavities.

The invention also relates to a structure including cavities.

The invention finds applications in numerous industrial fields and, in particular, for the manufacture of heat exchangers.

The invention is particularly interesting since it allows obtaining elements comprising cavities, the cavities possibly having simple or complex shapes.

### PRIOR ART

Currently, several methods are possible to make a structure comprising recessed portions.

A first solution consists in manufacturing the component by additive manufacture (or 3D printing). Parts with complex geometric shapes with good mechanical characteristics may be obtained. However, the dimensional and geometric tolerances are not often complied with.

A second solution consists in forming channels by removing material in a solid elementary part. However, such a machining technique does not allow obtaining all of the desired geometries, sections and lengths of the channels.

A third solution consists in assembling elementary parts together according to various techniques, like for example fusion welding, brazing, or diffusion welding.

Diffusion welding is currently one of the most promising approaches, and more particularly Hot Isostatic Pressing (HIP) welding. The pressing force is obtained by application of a pressurised gas over all of the walls of the components to be assembled. There are three methods for making a component including recessed portions with this technique.

The first method, shown in FIG. 1, consists in using tubes 1 which are sandwiched between two grooved plates 2, 3. The shape of the grooves is identical to the tubes. The tubes may be pre-deformed to obtain different sections (for example: square, rectangular) or to have different lengthwise curvatures.

However, with this first method, only recessed portions with simple geometric shapes could be obtained.

The second method, shown in FIG. 2, consists in carrying out an assembly by means of two diffusion welding cycles. Such a method is described in the document WO 2011/026925 A1. Several plates 4, 5, including at least one grooved plate, are superimposed. A bead is arranged between the two plates. A treatment step is carried out to obtain welding by diffusion of the material bead over the plates 4, 5. The first cycle is carried out at low pressure. The recessed portions are closed at the ends. Since the gas does not enter the interface, the diffusion welding is done. The junction is tight. However, pores with large dimensions remain and the assembly has a low mechanical strength. Thus, the method then comprises a step of consolidating the assembly by hot isostatic pressing, to obtain a diffusion welding of its elements. This cycle is launched at high pressure, the recessed portions are open to close the pores and suppress the junction.

The main drawback of this second method is that it is almost impossible to manufacture recessed portions without deforming them. Indeed, since no pressure is present inside the channels, during the first cycle, these could be deformed.

In order to avoid the deformation/the collapse of the channels, it is possible to insert, into the channels, a material that could be eliminated or removed afterwards, for example, chemically or mechanically. For example, such a solution is described in the document JP 2006/263746 A. However, it might be difficult, not only to find the proper filler material, but also to succeed in completely eliminating it.

A third method consists in carrying out a laser welding of plates 6 with thin dimensions over the channels formed in a substrate 7, and then welding a cap 8 over the obtained assembly. For example, this method is shown in FIG. 3. Such a method is also described in the document WO 2006/067349 A1. More particularly, this method comprises the following steps:
providing a substrate 7 in which grooves have been made in order to form the bottom of the recessed portion (FIG. 4A),
arranging blades 6 with a thin thickness at the top of the grooves in order to close the recessed portion (FIG. 4B),
welding the blades 6 to the substrate 7 by edge/edge laser welding in order to guarantee tightness (FIG. 4C),
depositing a cap 8 over the assembly formed by the substrate 7 and by the blades 6 (FIG. 4D),
welding the substrate 7 and the cap 8 by hot isostatic pressing diffusion (FIG. 4E).

However, this last method has many drawbacks. In particular, the interlocking of blades with thin thicknesses in the grooves require strict width tolerances (0.1 mm), which not only increases the machining costs but also complicate the method as it is still difficult to interlock and weld the thin blades in the interlockings without deformation, displacement and/or shift, in particular when it comes to recessed portions with complex shapes.

### DISCLOSURE OF THE INVENTION

The present invention aims to provide a method overcoming the drawbacks of the prior art and, in particular, a method allowing forming a structure comprising cavities, the cavities possibly having simple or complex shapes, while avoiding deformation, displacement and/or shift phenomena.

For this purpose, the present invention provides a method for manufacturing a structure comprising cavities, the method comprising the following steps:
a) forming recessed areas in a first face of a substrate made of a first material,
b) depositing a plate made of a second material over the first face of the substrate, so as to cover the recessed areas of the substrate,
c) carrying out a resistance welding, an electron-beam welding or a transparent laser welding, preferably under vacuum, around the recessed areas, whereby the plate is welded onto the substrate and cavities are formed,
d) carrying out a step of hot isostatic pressing diffusion welding on the obtained assembly.

The invention differs essentially from the prior art by the deposition of a plate over the substrate and by the implementation of a step of transparent welding, preferably under vacuum, of the plate onto the substrate over the entire contour of the recessed areas of the substrate to form tight cavities. Welding may consist of a transparent resistance welding, a transparent electron-beam welding or a transparent laser welding. This step ensures tightness at the substrate/plate junction. Thus, not only the boundary of the cavities is sealed but, in addition, this step limits, and possibly avoids, the pollution/oxidation of the trapped surfaces.

The use of a vacuum environment allows obtaining a thinner and more penetrating weld bead, at the same beam power as under a neutral gas. Welding takes place at the plate/substrate interface through the plate.

The hot isostatic pressing diffusion welding allows completing the assembly.

Advantageously, during step c), a transparent laser welding is carried out over the contour of the plate.

Since the weld bead is thinner and the atmosphere is homogeneous under vacuum (it is not necessary to have a gaseous protection together with the fusion like when welding under a neutral gas), it is possible to weld cavities with small widths and/or at the bottom of a narrow and deep well.

Advantageously, after step c), a step of degassing is carried out at the plate/substrate interface.

According to this advantageous variant, the method comprises, between step c) and step d), the following successive steps:
depositing a cowl over the plate,
welding the cowl onto the plate,
Advantageously, after having welded the cowl onto the plate, the method comprises a step during which a step of degassing is carried out at the plate/cowl interface.

Advantageously, the cowl is welded onto the plate by transparent laser welding, preferably under vacuum.

Advantageously, the first material and the second material are independently selected from among copper and its alloys, titanium and its alloys, aluminium and its alloys, steels and vanadium. The first material and the second material may be identical or different.

The method has many advantages:
obtaining a uniform weld (in terms of chemical composition and microstructure) almost free of residual stresses.
assembling identical materials together (such as steels, aluminium alloys, titanium alloys, copper alloys) or assembling materials with very different chemical compositions, (for example, steels/copper, steels/vanadium assemblies, etc.),
having a lower implementation cost compared to the methods of the prior art, and in particular a lower machining cost,
the ability to manufacture structures having cavities with complex shapes,
avoiding deformation phenomena,
not implementing an interlocking step.

The invention also relates to a structure obtained by such a method. The structure comprises:
a substrate made of a first material comprising recessed areas in a first face of the substrate,
a plate made of a second material covering the recessed areas of the substrate, the plate being welded onto the substrate around the recessed areas by a weld obtained by transparency, preferably under vacuum, by resistance welding, by laser welding and by electron-beam welding and by hot isostatic pressing diffusion, the recessed areas delimited by the substrate and the plate forming cavities,
possibly, a cowl welded onto the plate.

Advantageously, the first material and the second material are independently selected from among copper and its alloys, titanium and its alloys, aluminium and its alloys, steels, and vanadium. The first material may be identical to or different from the second material.

Advantageously, the structure is a heat exchanger comprising cavities arranged so as to make a fluid circulate, the cavities forming channels for the circulation of a fluid: a gas or a liquid (for example: N₂, water, mixture of molten metals).

Other features and advantages of the invention will appear from the following complementary description.

It goes without saying that this complementary description is given solely as an illustration of the object of the invention and should, in any case, be interpreted as a limitation of this object.

### BRIEF DESCRIPTION OF THE DRAWINGS

The present invention will be better understood upon reading the description of embodiments given for purely indicative and non-limiting purposes with reference to the appended drawings, wherein:

FIGS. 1 to 3 described before, show different embodiments according to the prior art.

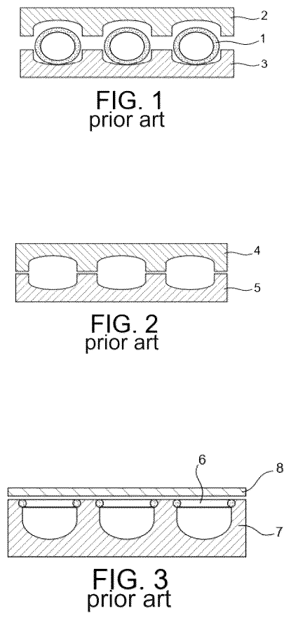

FIGS. 4A to 4E described before, show different steps of a method according to the prior art.

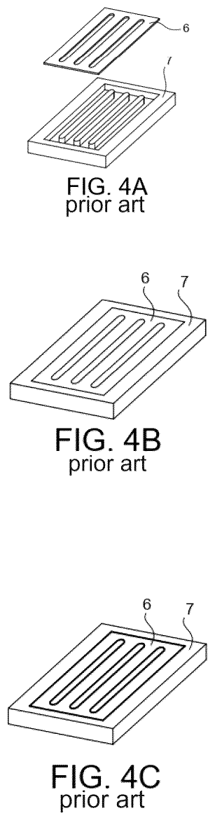

FIGS. 5A to 5D show different steps of a method according to a particular embodiment of the invention.

FIGS. 6A to 6E show different steps of a method according to another particular embodiment of the invention.

FIGS. 7A to 7B are schematic three-dimensional illustrations of different substrates used to implement the method according to different particular embodiments of the invention,

FIG. 8 is a photograph of different substrates used to implement the method according to another particular embodiment of the invention.

FIG. 9 is a photograph of different structures obtained after transparent laser-in-vacuum welding of a plate onto the different substrates of FIG. 8, according to another particular embodiment of the invention.

FIG. 10 is a metallographic section of the weld of one of the structures shown in FIG. 9.

The different portions shown in the figures are not necessarily plotted according to a uniform scale, to make the figures more readable.

The different possibilities (variants and embodiments) should be understood as not being exclusive of one another and may be combined together.

Furthermore, in the description hereinafter, terms that depend on the orientation, such as “top”, “bottom”, etc., of a structure apply while considering the structure being oriented in the manner illustrated in the figures.

### DETAILED DISCLOSURE OF PARTICULAR EMBODIMENTS

Although this is in no way restrictive, the invention finds a particular application in the manufacture of a structure including channels for the circulation of a fluid intended in particular, yet not exclusively, for heat exchange between two fluids.

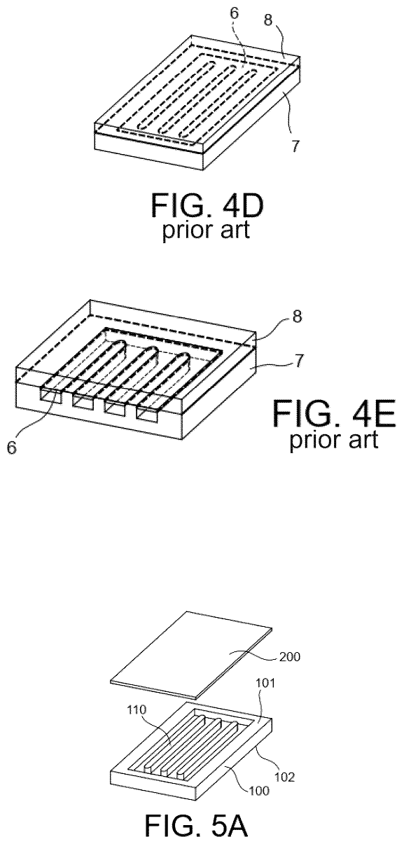

We will now describe in more detail a method for manufacturing a structure comprising cavities with reference to the appended FIGS. 5A to 5F. The method comprises the following steps:
a) forming recessed areas 110 in a first face 101 of a substrate 100 made of a first material (FIG. 5A),
b) depositing a plate 200 made of a second material over the first face 101 of the substrate 100, so as to cover the recessed areas of the substrate 100 (FIG. 5B),
c) carrying out a resistance welding, an electron-beam welding or a transparent laser welding, preferably under vacuum, around the recessed areas, whereby the plate 200 is welded onto the substrate 100 and tight cavities are formed (FIG. 5C),
d) carrying out a step of hot isostatic pressing diffusion welding on the obtained assembly (FIG. 5D).

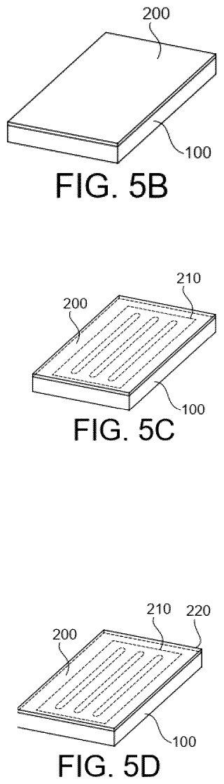

According to one variant, the method further comprises, between step c) and step d), the steps of depositing a cowl 300 over the plate 200 and of welding the cowl 300 to the plate 200. Thus, according to this variant, shown for example in the appended FIGS. 6A to 6E, the method comprises the following steps:
a) forming recessed areas 110 in a first face 101 of a substrate 100 made of a first material (FIG. 6A),
b) depositing a plate 200 made of a second material over the first face 101 of the substrate 100, so as to cover the recessed areas 110 of the substrate 100 (FIG. 6B),
c) carrying out a transparent welding such as resistance welding, a laser welding or an electron-beam welding, preferably, under vacuum around the recessed areas 110, whereby the plate 200 is welded onto the substrate 100 and tight cavities are formed (FIG. 6C),
   depositing a cowl 300 over the plate 200,
   welding the cowl 300 onto the plate 200 (FIG. 6D),
d) carrying out a step of hot isostatic pressing diffusion welding on the obtained assembly (FIG. 6E).

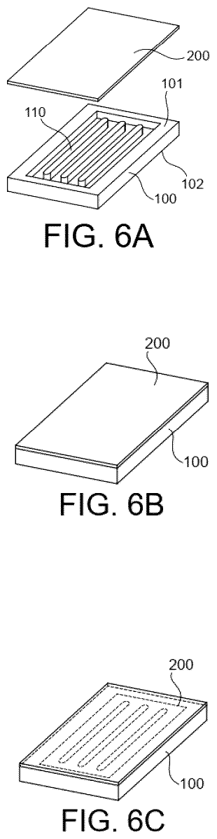

The substrate 100 comprises a first face 101 and a second face 102. The first face 101 may be parallel to the second face 102. It may also be not parallel to the second face 102. For example, the first face 101 may be planar (FIG. 7A) or have reliefs (FIG. 7B).

During step a), the substrate 100 is machined so as to form recessed areas. The recessed areas 110 may have simple shapes (for example longitudinal shapes). For example, the recessed areas consist of grooves (i.e. longitudinal cutouts that could be narrow). The recessed areas may also have complex shapes (for example, they may have turns, zigzags).

The recessed areas 110 may have quite varied sections and routings. In particular, it may have a rectangular, polygonal, semi-circular section. They may also have a section that varies according to their length. Their routing may be straight or not. It may feature back-and-forth segments and/or tight turns.

The recessed areas may be made in 2D (i.e. in the same plane (x, y)) or in 3D (i.e. their position may vary in a plane (x, y, z)).

Advantageously, each recessed area 110 opens at least at one of its ends. Preferably, the recessed areas have two ends and the two ends are open-through.

In a particular embodiment, it is possible to form recessed areas 110 in the first face 101 and in the second face 102 of the substrate 100. It is then possible to arrange another plate over the second face 102 of the substrate 100, the substrate being sandwiched between the two plates. This embodiment allows forming a compact structure.

Advantageously, all surfaces to be assembled are cleaned and/or pretreated (for example by chemical pickling or light machining) in order to obtain a clean surface and in order to improve the characteristics of the junction (for example the mechanical or electrical characteristics).

The plate 200 used during step b) is selected so as to be able to weld the plate onto the substrate by transparent welding. The plate 200 is deposited and aligned over the substrate 100. This adjustment is simple to implement because the plate 200 is a solid plate. The surface of the plate 200 covers at least all of the recessed areas 110. Preferably, it covers the entirety of the first face 101 of the substrate 100.

Advantageously, before being assembled, the plate 200 and the substrate 100 are cleaned and/or machined to remove the surface oxide that might be present at the surface of these parts and/or have a good roughness. Thus, the cleanness of the junctions to be assembled is guaranteed. This step leads to an improvement of the mechanical properties at the junction.

According to a first variant, the plate 200 may serve as a cap. This allows reducing the number of steps and elements necessary to the implementation of the method. Thus, the costs are reduced. The thickness of the plate 200 will be selected so as to be small enough to obtain a tight weld with the substrate 100.

According to another variant, a cowl 300 is subsequently welded onto the plate 200. The cowl 300 serves as a cap. The surface of the cowl 300 is at least equal to the surface of the plate 200. The cowl 300 is the counter-form that allows adding material where necessary.

According to this variant, the plate 200 may also include recessed areas. The recessed areas of the plate may be closed by the cowl 300. The cowl 300 may have no recessed areas or have recessed areas.

According to this variant, the thickness of the plate 200 may be thinner than in the variant where the plate also serves as a cap.

The first material of the substrate 100 and the second material of the plate 200 may be identical (i.e. it consists of a homogeneous assembly).

Alternatively, the first material and the second material may be different (i.e. it consists of an heterogenous assembly).

The first material and the second material may be selected independently of one another from among: copper and its alloys, titanium and its alloys, aluminium and its alloys, steels and vanadium. During step c), the face of the plate 200 arranged opposite the first face 101 of the substrate 100 and the first face 101 of the substrate 100 form the interface to be welded by diffusion.

The plate 200 is welded onto the substrate 100. Welding is carried out over the entire contour of the recessed areas 110. The obtained weld 210 follows the contour of the recessed areas 110 (FIG. 5C, 6C). The periphery of the interface is welded in a tight and degassed manner.

Thanks to welding, the use of brazing is not necessary. Hence, the maximum temperature at which the obtained element could be used is increased.

The transparent welding may be carried out by laser welding, by electron-beam welding or by resistance welding. Advantageously, for a resistance welding, the thicknesses of the elements to be welded will typically be smaller than 3 mm. The resistance welding may be carried out under air, under a controlled atmosphere or under vacuum.

Preferably, this step is carried out by laser welding, and even more preferably, it consists of a transparent laser-in-vacuum welding.

It is possible to form two weld beads for each recessed area 110. Nonetheless, if the recessed areas were very close to one another, one single weld bead could be enough.

The welding conditions are selected so as to achieve tightness at the substrate/plate junction.

Thus, the pressurised gas which will be applied during the Hot Isostatic Pressing (HIP) cycle and which will enter the recessed portions will not be present at the substrate 100/plate 200 interface between two laser weld beads.

Advantageously, a metallographic section may be carried out on test samples in order to verify the complete penetration of the bead and the absence of any prohibitive defect in the weld beads as defined in the standard NF EN ISO 13919 but this control is destructive.

Advantageously, a helium tightness test with a leak detection limit of 1×10⁻¹⁰ mbar.l.s⁻¹ according to the standard NF EN ISO 20485 may be carried out to guarantee good tightness of the transparent vacuum welding of each channel of the substrate 100. This control is non-destructive.

Advantageously, an X-ray radiography or tomography may be done to verify the absence of a redhibitory defect in the weld beads as defined in the standard NF EN ISO 13919. This control is non-destructive.

Advantageously, during step c), the contour of the substrate 100/plate 200 interfaces is also welded. The weld 220 allows making the assembly tight (FIG. 5D). Where appropriate, the contour of the cowl 300/plate 200 interfaces is also welded. The weld 310 allows making the assembly tight (FIG. 6D). Preferably, welding of the contours is carried out by vacuum welding.

Upon completion of step c), the formed cavities are tight.

To implement step d), the cavities are open at least at one of their ends so that the gas could thus circulate inside the recessed portions. Thus, during step d), the pressure inside the cavities may increase and there is no deformation of the channels during the implementation of this step. This opening may be provided for during the step of machining the substrate 100, prior to the HIP cycle.

Advantageously, before step d), the substrate 100/plate 200 and/or cowl 300/plate 200 interfaces are degassed under secondary vacuum.

During step d), the HIP diffusion welding is carried out. Sealing of the recessed areas 110 by means of the plate 200 welded during step c) makes the HIP diffusion welding possible with no significant deformation of the formed channels.

This diffusion welding is done in a solid phase. A temperature of about 0.5 to 0.9×Tf the melting point of the material and a high pressure are applied on the components to be assembled.

As regards steels and nickel alloys, the welding temperature is typically selected between 900° C. and 1,250° C. The pressure is typically between 700 bars and 1,500 bars (namely between 8×10⁷ Pa and 1.5×10⁸ Pa). For example, the welding time is comprised between 1 h and 10 h, preferably between 2 h and 5 h.

In a first step, the contact is done at the rough material spikes. Then, different diffusion mechanisms as well as a migration of the seal of the grain seals close the pores. Thus, the interface between the two parts to be assembled disappears.

If the vacuum of the laser welding of step c) is not satisfactory, it is possible to carry out, before the HIP diffusion welding step, a step during which holes are formed, for example, by drilling and pumping nozzles (i.e. tubes that allows drawing vacuum at the substrate/plate and/or plate/cowl interfaces). The higher the vacuum at the interfaces to be welded, the better the mechanical characteristics of the junction will be.

Diffusion welding produces no deformation of the channels.

In a particular variant, after the diffusion welding step, it is possible to reduce the thickness of the different elements of the structure in order to obtain the desired dimensions of the part to be made.

### Illustrative and Non-Limiting Examples of One Embodiment

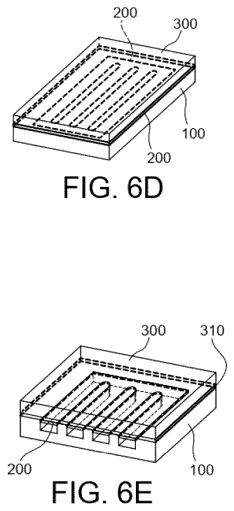

In this example, a substrate 100 with zigzag-like recessed areas 110, and more particularly M-shaped recessed areas, has been manufactured (FIG. 8). The substrate 100 is made of steel.

A plate 200 made of steel has been placed over the substrate. Then, the following steps are carried out:
a step of transparent laser-in-vacuum welding is carried out to weld the plate 200 onto the substrate 100, by means of a weld 210, and thus form tight cavities; the contour of the substrate 100 and of the plate 200 has also been welded by transparent laser welding,
a step of hot isostatic pressing diffusion welding of the obtained assembly.

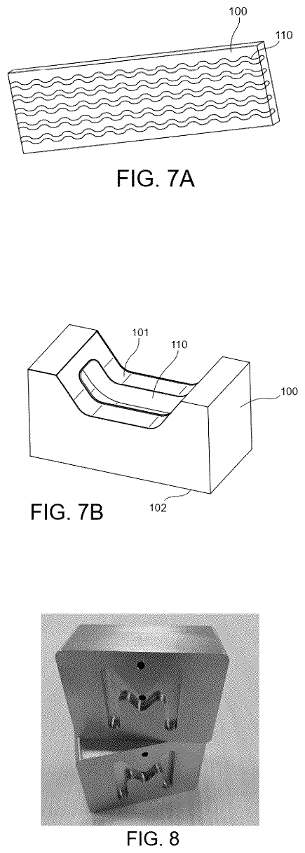

FIG. 9 shows the part obtained after the transparent laser-in-vacuum welding step.

A helium test has been carried out to verify the tightness of the laser weld. The test is that one described in paragraph A.3 of the standard ISO 20485:2018 (“Non-destructive testing—Leak testing—Tracer gas method”). The part has a good tightness.

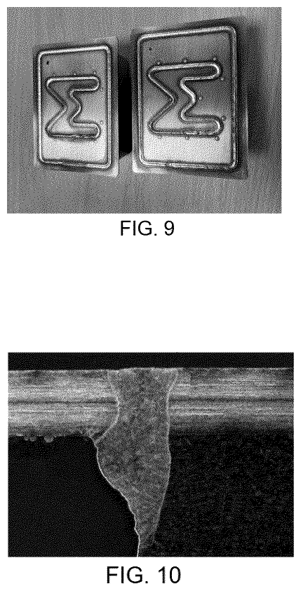

A metallographic section confirms that the weld 210 penetrates into the substrate 100 (FIG. 10).

1. A method for manufacturing a structure comprising cavities, the method comprising the following steps:
a) forming recessed areas in a first face of a substrate made of a first material,
b) depositing a plate made of a second material over the first face of the substrate, so as to cover the recessed areas of the substrate,
c) carrying out a resistance transparent welding under vacuum or a transparent laser-in-vacuum welding, around the recessed areas, whereby the plate is welded onto the substrate and cavities are formed, and
d) carrying out a step of hot isostatic pressing diffusion welding on the obtained assembly.

2. The method according to claim 1, wherein, during step c), a transparent laser welding is carried out over the contour of the plate.

3. The method according to claim 1, wherein, after step c), a step of degassing is carried out at the plate/substrate interface.

4. The method according to claim 1, further comprising, between step c) and step d), the following successive steps:
depositing a cowl over the plate, and
welding the cowl onto the plate.

5. The method according to claim 4, further comprising, after welding the cowl onto the plate, a step of degassing is carried out at the plate/cowl interface.

6. The method according to claim 4, wherein the cowl is welded onto the plate by laser welding, preferably under vacuum.

7. The method according to claim 6, wherein the laser welding is performed under vacuum.

8. The method according to claim 1, wherein the first material and the second material are independently selected from among copper and its alloys, titanium and its alloys, aluminium and its alloys, steels and vanadium.

9. The method according to claim 8, wherein the first material and the second material are identical.

10. The method according to claim 8, wherein the first material and the second material are different.

11. A structure comprising:
a substrate made of a first material comprising recessed areas in a first face of the substrate, and
a plate made of a second material covering the recessed areas of the substrate, the plate being welded onto the substrate around the recessed areas by a weld obtained by vacuum transparency, by resistance welding or by laser welding and by hot isostatic pressing diffusion, the recessed areas delimited by the substrate and the plate forming cavities.

12. The structure according to claim 11, further comprising a cowl welded onto the plate.

13. The structure according to claim 11, wherein the first material and the second material are independently selected from among copper and its alloys, titanium and its alloys, aluminium and its alloys, steels and vanadium.

14. The structure according to claim 13, wherein the first material and the second material are identical.

15. The structure according to claim 13, wherein the first material and the second material are different.

16. The structure according to claim 11, wherein the structure is a heat exchanger comprising cavities arranged so as to make a fluid circulate, the cavities forming channels for the circulation of a fluid.

17. The structure according to claim 16, wherein the fluid is a gas.

18. The structure according to claim 16, wherein the fluid is a liquid.
